(19) United States
(12) Patent Application Publication
(10) Pub. No.: US 2012/0033221 A1
(43) Pub. Date: Feb. 9, 2012

(54) IMAGE ACQUISITION APPARATUS INCLUDING ADAPTIVE OPTICS

(75) Inventor: Kenichi Saito, Yokohama-shi (JP)

(73) Assignee: CANON KABUSHIKI KAISHA, Tokyo (JP)

(21) Appl. No.: 13/260,452

(22) PCT Filed: Apr. 23, 2010
(86) PCT No.: PCT/JP2010/057730

§ 371 Date: Sep. 26, 2011

(30) Foreign Application Priority Data
May 8, 2009 (JP) 2009-113774

(51) Int. Cl. G01N 21/55

(52) U.S. Cl. 356/445

(57) ABSTRACT

An image forming apparatus including an adaptive optics realizing a reduction in image acquisition time and high definition without significantly increasing a light amount of a beam for scanning is provided, the apparatus including an adaptive optics scanning a plurality of areas in an object with a deflector using a measuring beam including a plurality of beams and corrects reflected and/or scattered beam from the object to acquire an image of the object, including: one or more wavefront aberration detecting device detecting wavefront aberration in each of the plurality of beams caused by the object when scanned by the measuring beam including the plurality of beams; and a single wavefront aberration correcting device correcting the wavefront aberration of each of the plurality of beams according to the detected wavefront aberration, the single wavefront aberration correcting device arranged in a position optically conjugate with the deflector.

### TECHNICAL FIELD

The present invention relates to an image acquisition apparatus including an adaptive optics, and, more particularly to a technique for enabling acquisition of a two-dimensional image or a three-dimensional image at high resolution, concerning, for example, in vivo tissue such as a retina of an eye as an object.

### BACKGROUND ART

As an image acquisition apparatus that performs acquisition of an image of in vivo tissue such as a retina of an eye as an object in a non-invasive manner, there are known an SLO (Scanning Laser Ophthalmoscope) capable of acquiring a two-dimensional image, an OCT (Optical Coherence Tomography) capable of picking up a tomographic image of an object, and the like. These apparatuses can scan a light beam on a retina using a deflector, measure reflected beam or scattered beam, and form two-dimensional images and three-dimensional images. At present, there is a demand for a further reduction in image acquisition time and higher definition of images. For the reduction in the image acquisition time, systems that can realize a further reduction in measurement time than the original TD-OCT (Time Domain OCT), i.e., an SD-OCT (Spectrum Domain OCT) and an SS-OCT (Swept Source OCT) are developed.

For the high definition of images, there is known an apparatus including a wavefront aberration correcting device that detects a wavefront disordered in an eyeball and offsets the wavefront using a technique of an adaptive optics (AO).

As such an apparatus, Japanese Patent Application Laid-Open No. 2005-224328 proposes an image acquisition apparatus with aberration correction that causes a single deformable mirror (DM) to act on light of a single beam from an object a plurality of times and secures a correction amount, in order to secure a necessary aberration correction amount.

When an object is of extremely small reflectance such as a retina (the reflectance of the retina is in the order of 10⁻³%), reflected beam and scattered beam are extremely weak. Therefore, in the case of an optical system including lenses, in some case, surface reflected beams from respective surfaces form a ghost image and a wavefront of a signal beam cannot be correctly measured.

In order to prevent such a phenomenon, in general, a concave mirror decentered with respect to an optical axis is used as an optical system between a wavefront aberration detecting device and an object.

When the concave mirror is used, in order to reduce optical path length while suppressing aberration as much as possible, Nathan Doble et al., “Use of a microelectromechanical mirror for adaptive optics in the human eye”, Optics Letters, Sep. 1, 2002, Vol. 27 No. 17, PP. 1537-1540, reports an example in which a parabolic (rotational symmetrical aspherical) mirror is used instead of a spherical mirror.

### DISCLOSURE OF THE INVENTION

However, the apparatus including the wavefront aberration correcting device by the single beam described above has a problem in attaining the reduction in image acquisition time instead the apparatus can attain the high definition of images. Specifically, if scanning speed is increased for the reduction in image acquisition time, it is necessary to increase a light amount of a beam in order to secure an S/N ratio.

However, if an object is a retina of an eye, energy that can be irradiated is limited to prevent the retina of the eye from being damaged.

Since the energy that can be irradiated is limited in this way, in the apparatus in the conventional example by the single beam, it is difficult to realize the increasing of the light amount of the beam to reduce the image acquisition time.

Another way to reduce the image acquisition time is to use a plurality of beams. However, in order to increase resolution in the lateral direction, it requires preparing wavefront aberration correcting systems independently for the respective beams. The size of an overall optical system thus becomes too large and cost also increases.

When the object is the object having extremely small reflectance such as a retina as described above, as the optical system, it is necessary to adopt the configuration of a decentered reflecting optical system.

When the decentered reflecting optical system is adopted, in the case of the single beam, a spherical mirror having extremely long focal length can be used and a rotational symmetrical aspherical surface may be used. However, in the case of the plurality of beam, it is difficult to suppress aberration simultaneously using these methods.

In view of the above problems, it is an object of the present invention to provide an image acquisition apparatus including a compact adaptive optics that can realize high definition of images while keeping a light amount of a beam used for scanning suppressed within a specified light amount of a safety standard or the like.

The present invention provides an image acquisition apparatus including an adaptive optics configured as described below.

An image acquisition apparatus according to the present invention is an image acquisition apparatus including an adaptive optics that scans a plurality of areas in an object with a deflector using a measuring beam including a plurality of beams and corrects, with the adaptive optics, reflected beam and scattered beam from the object to acquire an image of the object, the image acquisition apparatus characterized by comprising:

a single wavefront aberration detecting device that detects wavefront aberration in each of the plurality of beams caused by the object when the object is scanned by the measuring beam including the plurality of beams; and

a single wavefront aberration correcting device that corrects the wavefront aberration of each of the plurality of beams according to the wavefront aberration detected by the wavefront aberration detecting device, the single wavefront aberration correcting device being arranged in a position optically conjugate with the deflector.

Another image acquisition apparatus according to the present invention is an image acquisition apparatus including an adaptive optics that scans an object with a deflector using a measuring beam and corrects, with the adaptive optics, reflected beam and scattered beam from the object to acquire an image of the object, the image acquisition apparatus characterized by comprising:

a wavefront aberration detecting device that detects wavefront aberration of the measuring beam caused by the object when the object is scanned by the measuring beam;

a wavefront aberration correcting device that corrects the wavefront aberration of the measuring beam according to the wavefront aberration detected by the wavefront aberration detecting device, the wavefront aberration correcting device being arranged in a position optically conjugate with the deflector; and

at least one aspherical mirror not having a rotation axis of symmetry, the aspherical mirror being arranged between arrangement positions of the wavefront aberration correcting device and the deflector.

According to the present invention, it is possible to realize an image acquisition apparatus including a compact adaptive optics that can realize high definition of images while keeping a light amount of a beam used for scanning suppressed within a specified light amount of a safety standard or the like.

Further features of the present invention will become apparent from the following description of exemplary embodiments with reference to the attached drawings.

### BRIEF DESCRIPTION OF THE DRAWINGS

FIG. 1 is a diagram for describing an image acquisition apparatus including an adaptive optics in Example 1 of the present invention;

FIG. 2A is a conceptual diagram for describing a basic mechanism of realization of high definition of images when an adaptive optics (AO) is applied to an ophthalmoscopy system;

FIG. 2B is a conceptual diagram illustrating the structure of an HS sensor;

FIG. 3A is a conceptual diagram for describing the configuration of a light image acquisition apparatus by a plurality of beams including an adaptive optics according to an embodiment of the present invention;

FIG. 3B is a diagram illustrating another configuration example in the embodiment of the present invention;

FIG. 4 is a diagram for describing a pupil conjugate optical system using a concave mirror according to the embodiment of the present invention;

FIGS. 5A, 5B, 5C, and 5D are diagrams for describing residual wavefront aberration in relation with types of aspherical shapes in the embodiment of the present invention;

FIGS. 6A, 6B, 6C, and 6D are diagrams for describing a local radius of curvature characteristic of an aspherical mirror in the embodiment of the present invention;

FIG. 6E is a diagram for describing Rₓ and R_{y} in the embodiment of the present invention;

FIG. 7 is a diagram for describing a configuration example of wavefront aberration detecting device arrangement in the embodiment of the present invention;

FIGS. 8A, 8B, 8C, 8D, 8E, and 8F are diagrams for describing residual wavefront aberration in Example 2 of the present invention;

FIG. 8G is a diagram for describing an angle of view position where wavefront aberration in the second embodiment of the present invention is acquired; and

FIG. 9 is a diagram for describing a configuration example in which an adaptive optics of the present invention is applied to an OCT in Example 3.

### BEST MODE FOR CARRYING OUT THE INVENTION

An image acquisition apparatus including an adaptive optics in an embodiment of the present invention is described below.

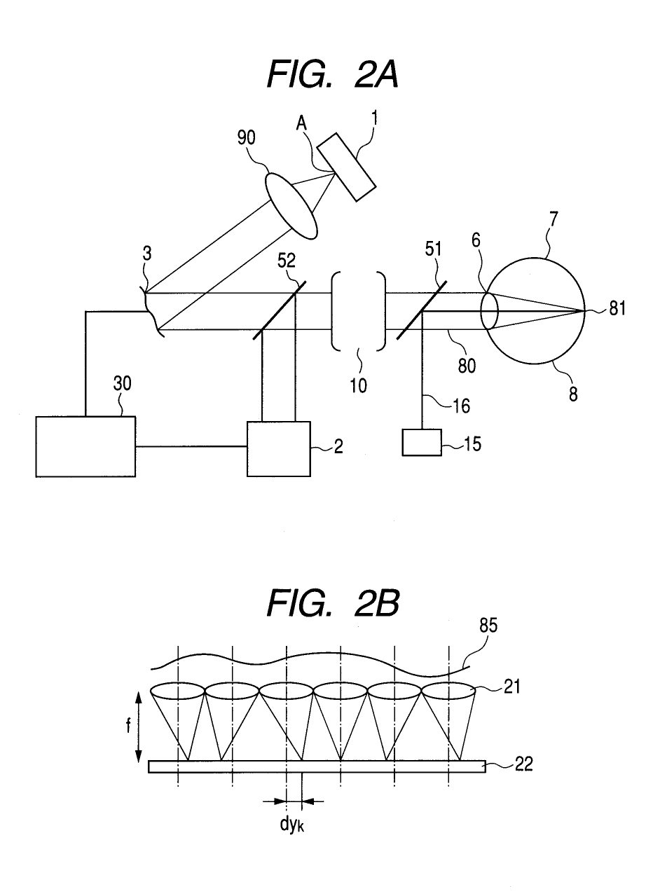

First, a mechanism of realization of high definition of images when an adaptive optics (AO) is applied to an ophthalmoscopy system is described using FIG. 2A.

In order to optically acquire information concerning a retina 8 of an eyeball 7, the retina is irradiated by a measuring beam by not-illustrated illumination beam and reflected/scattering beam from a certain point 81 on the retina is focused on a beam reception sensor 1 via optical systems 10 and 90.

In the case of a fundus camera, the light reception sensor 1 is an imaging device in which light reception units are arranged in a matrix shape. When the light reception sensor 1 is equivalent to one of an SLO and an OCT, a portion in a position A of the light reception sensor 1 is equivalent to an optical fiber end for leading beam to light receiving elements of one of the SLO and the OCT.

When it is attempted to obtain high-resolution information, it is necessary to enlarge an exit pupil 6 (an incident beam diameter) of the optical system 10. In that case, reflected/scattered beam 80 from the retina emitted from the eyeball falls in a state in which a wavefront thereof is disordered because of aberration of the eyeball.

Even if the beam is focused on the light reception sensor 1 by the optical systems 10 and 90, the beam is not condensed by focusing performance inherent in the optical systems and forms a disordered and spread spot. Therefore, spatial resolution in the lateral direction is not sufficiently obtained, and desired high-resolution information cannot be obtained.

The aberration includes high-order aberration such as comatic aberration and quaternary spherical aberration besides low-order aberration such as astigmatism, defocus, and tilt that can be corrected by a normal optical element such as a cylindrical lens.

This is caused by distortion and nonuniformity of indices of refraction of mainly a curved surface of an anterior ocular segment such as a cornea and a crystalline lens. However, since an individual difference is large and it temporally changes by a state of a tear layer or the like, it is necessary to correct the aberration every respective time.

On the other hand, there is widely known a method of measuring occurred wavefront aberration and giving aberration having an opposite characteristic for offsetting the wavefront aberration to correct the wavefront aberration. The method is generally referred to as adaptive optics (AO).

As a wavefront aberration detecting device as a unit that detects wavefront aberration, microlens periodically set side by side in a matrix shape are arranged apart from a light receiving surface of a two-dimensional imaging device by focal length of the microlenses. Then, an aberration amount is calculated according to displacement of a spot condensed on a light receiving surface by lens elements (a Shack-Hartmann system).

As a wavefront aberration correcting device 3 as a unit that corrects a wavefront, a system for changing a shape of a reflective mirror is mainly used.

In this systems, a plurality of actuators is provided behind a thin flexible mirror and the mirror is locally pushed and pulled by using electrostatic force, magnetic force, or a piezo-element to change an overall shape of the mirror.

There is also known a system for drawing out and inserting divided micro-mirrors while the mirrors are tilted. In general, the mirrors have a local displacement amount of sub-μm to ten and several μm and do not have an ability enough for substantially changing the focal length of an optical system.

A wavefront aberration detecting device 2 and the wavefront aberration correcting device 3 are arranged in position optically conjugate with the pupil 6 of the eyeball. A correction amount of the wavefront aberration correcting device 3 is calculated on the basis of data detected by the wavefront aberration detecting device 2 to set a shape.

In the configuration illustrated in FIG. 2A, in a scanning optical system 10, a deformable mirror 3 (hereinafter referred to as DM 3) as a wavefront aberration correcting device is arranged in a position conjugate with the exit pupil (the pupil of the eyeball). A Shack-Hartmann (HS) sensor 2 as a wavefront aberration detecting device is arranged in a position branched by a beam splitter (a splitting unit) 52 and also conjugate to the exit pupil.

A light source 15 is prepared for wavefront aberration detection. A beam 16 from the light source is made incident on the eyeball 7 via a beam splitter (a splitting unit) 51 and condensed at the measuring point 81 on the retina 8. A reflected/scattered beam 80 from the measuring point 81 is converted into substantially collimated beams by an eyeball optical system such as a retina, transmitted through the beam splitter 51, and converted into a beam having predetermined thickness by the scanning optical system 10. Thereafter, a part of the reflected/scattered beam 80 is reflected by the beam splitter 52 and made incident on the HS sensor 2.

The structure of the HS sensor 2 is illustrated in FIG. 2B.

Beams made incident on the HS sensor 2 with a wavefront indicated by a wavy line 85 forms respective spots on a two-dimensional light receiving element 22 through sub-apertures of lens elements of a microlens array 21 arranged in a position optically conjugate with the pupil.

The spots are focused in positions deviating by dyₖ from respective microlens optical axis position (indicated by broken lines) on the two-dimensional light receiving element 22 according to a gradient of a wavefront made incident on the sub-apertures. When the focal length of a microlens is represented as f, a gradient yₖ of the wavefront is calculated as yₖ=dyₖ/f.

When the number of microlenses is represented as M and the number of actuators of the DM 3 is represented as N, a wavefront gradient vector y and a correction signal vector a of the DM 3 are represented by the following relation:

y=[B]a (1)

where

$$y = ( \begin{matrix}{y}_{1} \\ {y}_{2} \\ ⋮ \\ ⋮ \\ {y}_{M}\end{matrix} ) , a = ( \begin{matrix}{a}_{1} \\ {a}_{2} \\ ⋮ \\ ⋮ \\ {a}_{N}\end{matrix} ) , B = ( \begin{matrix}{B}_{11} & {B}_{12} & … & {B}_{1 N} \\ {B}_{21} & {B}_{22} & … & {B}_{2 N} \\ ⋮ & ⋮ & … & ⋮ \\ ⋮ & ⋮ & … & ⋮ \\ {B}_{M 1} & … & … & {B}_{MN}\end{matrix} )$$

A matrix B represents a relation of interaction between a wavefront gradient amount and respective actuator correction signal values of the DM 3 for forming the wavefront gradient amount.

Expression (1) represents wavefront aberration that occurs when a shape of the DM 3 changes. Respective values of the matrix depend on how the shape of the DM 3 changes according to a correction signal value. However, the values are different depending on a type of the DM 3.

In the DM 3 of the type for changing the shape with the divided mirrors as described above, when a certain micro-mirror is changed, the change does not affect a micro-area around the micro-mirror. However, in a type for changing the shape as a continuous surface, since the change affects an area around the mirror, a value of B also depends on the change.

Conversely, in order to calculate a correction signal value for the DM 3 for correcting wavefront aberration currently detected by the HS sensor, inverse conversion of Expression (1) may be performed. However, since an inverse matrix of B is not calculated in general, a pseudo-inverse matrix [B]⁻¹ is used here.

The pseudo-inverse matrix [B]⁻¹ is represented as [B]⁻¹=[B^{T}B]⁻¹B^{T} by using a permutation matrix B^{T}:

where

$${B}^{T} = ( \begin{matrix}{B}_{11} & {B}_{21} & … & {B}_{M 1} \\ {B}_{12} & {B}_{22} & … & {B}_{M 2} \\ ⋮ & ⋮ & … & ⋮ \\ ⋮ & ⋮ & … & ⋮ \\ {B}_{1 N 1} & … & … & {B}_{MN}\end{matrix} )$$

Therefore, when measured wavefront aberration (tilt in the respective sub-apertures of the wavefront) is represented as y, an actuator correction signal value a to the DM 3 is calculated as:

a=[B^{T}B]⁻¹B^{T}y (2)

The above is a procedure of conceptual calculation. However, actual numerical values are determined according to, for example, a relation between sub-apertures of wavefront gradation detected by the HS sensor and an actuator position of the DM 3.

Referring back to the system illustrated in FIG. 2A, with a value of y measured by the HS sensor 2 as described above and calculated by a calculating apparatus 30 and a value of B set in advance according to characteristics of the elements, the DM 3 changes the shape according to the value calculated by Expression (2).

If the apparatus represented in FIG. 2A is a fundus camera, the light source 15 that irradiates the point 81 on the retina is used in order to detect the wavefront. Reflected/scattered beam, used for obtaining an image, from the measuring point 81 of the fundus portion illuminated by a not-shown illuminating unit is being transmitted through an anterior ocular segment 6 and the scanning optical system 10. Thereafter, a wavefront of the reflected/scattered beam is corrected by the DM 3 having a shape changed as described above. The reflected/scattered beam is focused on the light reception sensor 1 by the focusing lens 90. On the other hand, in the case of an SLO or an OCT, an illumination beam from the SLO or the OCT for obtaining an image is also used as an irradiation beam for detecting a wavefront. A position A of the light reception sensor 1 is equivalent to a fiber end of one of the SLO and the OCT. Light emitted from the fiber end A is made incident on the eyeball via the DM 3 and the scanning optical system 10 and illuminates the measuring point 81 on the retina.

At this point, when the DM 3 is not driven, a condensing spot on the retina is a spot disordered and spread by the aberration of the eyeball. However, since the beam is corrected by the DM 3, the beam is condensed at a spot conforming to desired resolution.

Reflected/scattered beam from this point is made incident on the fiber end A reversely via the anterior ocular segment 6, the scanning optical system 10, the DM 3, and the lens 90 and, thereafter, propagates through a fiber of the SLO or the OCT.

Focusing performance of the spot on the fiber end A is also improved by the correction by the DM 3. Therefore, satisfactory fiber coupling efficiency can be obtained. An S/N ratio of an image obtained as a result is also improved.

With the wavefront aberration correction technique described above, high definition of images can be realized. However, there is still a problem in attaining the reduction in image acquisition time aimed at by the invention in the case a single beam is used. Specifically, as described above, it is an object of the present invention to attain high resolution and realize the reduction in image acquisition time.

As described above, when scanning speed of a beam is increased, a light amount of the beam has to be increased to secure an S/N ratio. However, in the case of an ophthalmoscopy apparatus, in preventing damage to an eye, energy that can be irradiated per a unit area of a retina is limited by the safety standard.

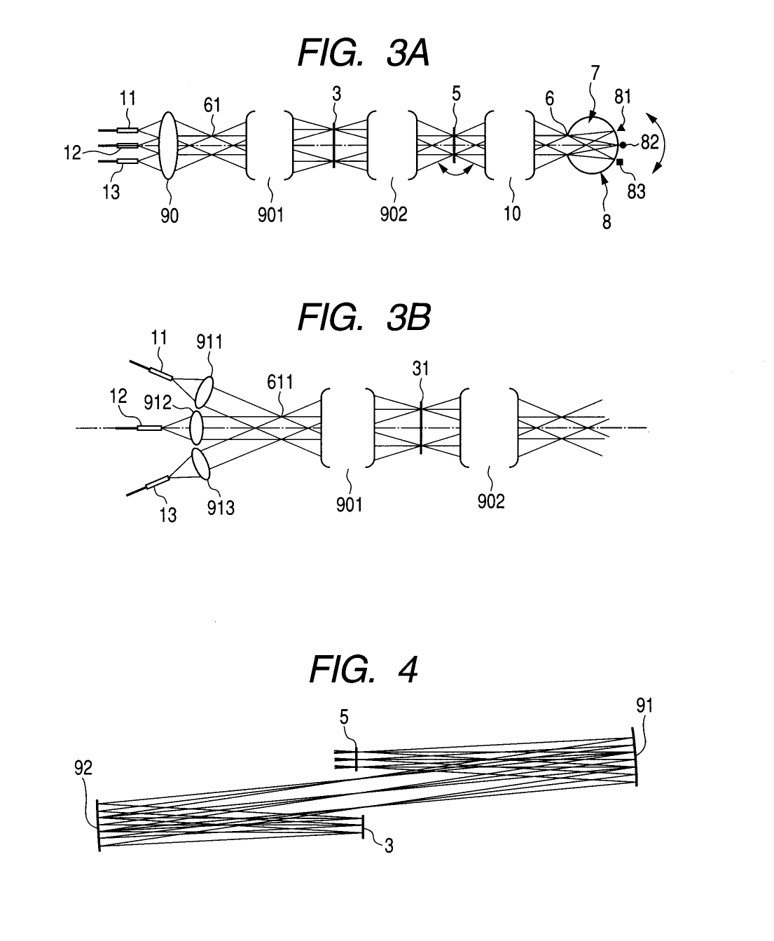

In order to build a system while keeping a light amount of such an irradiation beam suppressed within a specified amount of the safety standard or the like, an adaptive optics using a plurality of beams illustrated in FIG. 3A is used in this invention, which makes the plurality of beams incident on an eyeball while separating the beams by a certain degree of distance (specifically, a distance enough for the beams not affecting one another in an object) and simultaneously scans divided respective areas.

The adaptive optics using a plurality of beams is configured to perform wavefront aberration correction for the plurality of beams with a set of a single wavefront aberration detecting device and a single wavefront aberration correcting device.

Specifically, since aberration of an ocular optical system affects all the plurality of beams, when large-diameter beams are used to realize high resolution, correction for wavefronts of respective beams is necessary. In that case, if wavefront aberration detecting devices and wavefront aberration correcting devices are prepared by the number of beams made incident, the optical system is increased in size and cost is also substantially increased.

However, with the configuration of the present invention, a reduction in size of the optical system and a reduction in cost are realized by performing the wavefront aberration correction for the plurality of beams with the single wavefront aberration detecting device and the single wavefront aberration correcting device.

Specifically, the wavefront aberration detecting device is arranged in a position optically conjugate with the wavefront aberration correcting device. The wavefront aberration detecting device arranged in the position optically conjugate with the wavefront aberration correcting device is capable of detecting one beam among a plurality of beams and measuring wavefront aberration of the beam. A correction amount due to the wavefront aberration is applied to the plurality of beams. In this way, with the above configuration of the present invention, it is possible to realize an image acquisition apparatus including an adaptive optics capable of realizing the reduction in image acquisition time with a compact configuration while keeping a light amount of a beam suppressed within a specified light amount of the safety standard or the like in order to increase scanning speed of the beam.

In FIG. 3A, three optical fiber ends 11, 12, and 13 respectively emit divergent beams and correspond to the position A in FIG. 2A. The divergent beams emitted from the optical fiber ends 11, 12, and 13 are respectively changed to collimated beams by a common collimator optical system 90 and made incident on the wavefront aberration correcting device 3 via a relay optical system 901. At this point, the respective beams are made incident at different angles and coincide with one another on the surface of the wavefront aberration correcting device 3. A wavefront of at least one beam is detected by a not-shown wavefront aberration detecting device. The beams are simultaneously corrected by the single wavefront aberration correcting device 3 according to a value of the wavefront.

Thereafter, the respective beams are deflected by a deflector 5 such as a galvanometer mirror and made incident on the pupil 6 by the scanning optical system 10, via a relay optical system 902.

The incident beams form spots 81, 82, and 83 on the retina 8 by the anterior ocular segment such as the cornea. When the deflector 5 is rotated in a direction of an arrow in the figure, the spots 81, 82, and 83 also move in a direction of an arrow in the figure. In this way, the retina 8 is two-dimensionally scanned.

At this point, the spots 81, 82, and 83, disordered by aberration of the ocular optical system if not corrected, are satisfactorily focused because a wavefront is corrected by the wavefront aberration correcting device 3 and has a desired spot diameter.

Reflected/scattered beams from these spots are emitted from the pupil 6 reversely through the anterior ocular segment and made incident on the wavefront aberration correcting device 3 again via the scanning optical system 10 to the relay optical system 902.

The reflected/scattered beams are affected by the aberration of the ocular optical system again and have wavefront aberration. However, the reflected/scattered beams are corrected by the wavefront aberration correcting device 3 again.

Consequently, the reflected/scattered beams are respectively satisfactorily condensed at the fiber ends 11, 12, and 13 via the relay optical system 901 and the collimator optical system 90 and optically coupled to the fibers at high efficiency. It is possible to perform measurement at three-fold speed without increasing a light amount by performing scanning using three beams.

To conceptually describe the invention, FIG. 3A is illustrated like a coaxial system by simplifying optical system. However, when an object has extremely low reflectance like a retina of an eye and reflected/scattered beam is weak, as described in the summary of the invention, in general, as an optical system between a wavefront aberration detecting device and an eyeball, a decentered reflecting optical system in which a concave mirror is arranged rather than a reflective lens is adopted.

A correction ability of a wavefront aberration correcting device is from several μm to as large as ten and several μm.

Therefore, when it is attempted to correct second-order to high-order components in wavefront aberration that occurs in the eyeball with respect to an incident beam having a diameter of 6 to 7 mm, it is necessary to consume most of the ability for eyeball wavefront aberration correction.

Therefore, when aberration of an optical system remains more than a fixed amount, in some case, a part of the correction ability of the wavefront aberration correcting device is used for correction of the aberration and an ability necessary for the eyeball wavefront aberration correction cannot be sufficiently secured. To prevent such a situation, it is necessary to suppress residual aberration of the relay optical systems 901 and 902, which form a conjugate relation, as small as possible and, if possible, within 0.3 λ in a PV value of wavefront aberration and to a degree equal to or higher than 0.9 in a corresponding Strehl ratio.

In the case of a single beam, as in the conventional example, if, in a spherical mirror, focal length is extended and an incident angle to mirrors is reduced or if a rotational symmetrical aspherical mirror is used, the suppression of the residual aberration can be realized.

On the contrary, when it is attempted to sufficiently suppress aberration caused by the optical system for each of the plurality of beams described above, a rotational symmetrical mirror is insufficient.

This is because it is nothing but configuring a decentered reflecting optical system having an angle of view. The suppression of the aberration is described with reference to an optical system for actually forming two optically conjugate positions (pupil conjugate positions) shown in FIG. 4.

In the following description, three beams are used. Focal length of mirrors is about 100 mm and a pupil magnification is one.

An angle among the respective beams in the pupil is 3°. For example, the deflector 5 and the wavefront aberration correcting device 3 are arranged as shown in FIG. 4. Two mirrors 91 and 92 are provided between arrangement positions of the deflector 5 and the wavefront aberration correcting device 3.

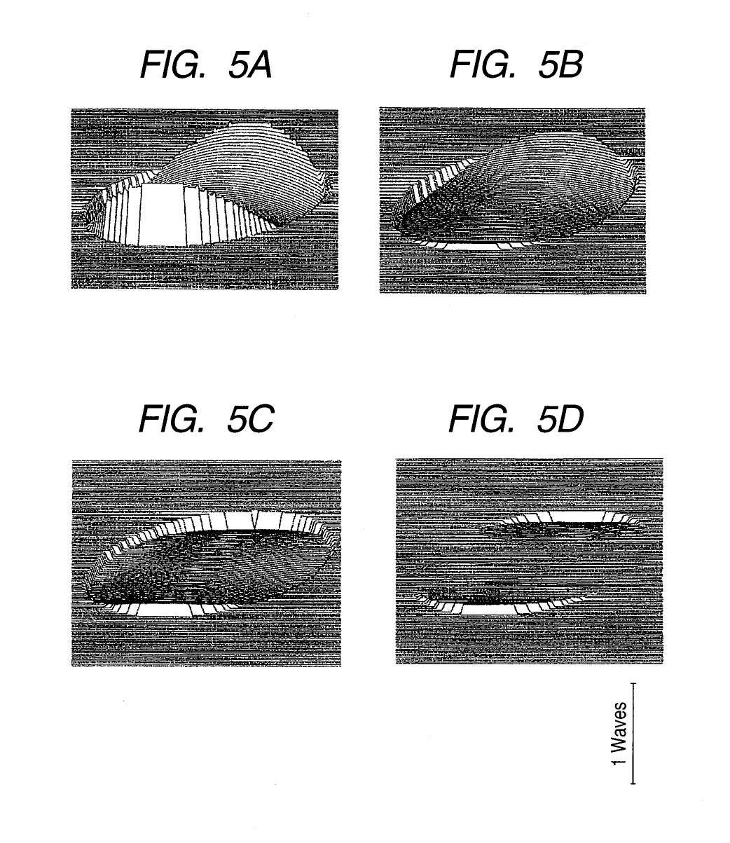

A wavefront aberration amount of a certain angle of view beam at the time when the optical system is optimally designed is shown in FIGS. 5A, 5B, 5C, and 5D. In FIG. 5A, both the two mirrors 91 and 92 have conic aspherical surfaces, in FIG. 5B, both the two mirrors 91 and 92 have toroidal surfaces, in FIG. 5C, both the two mirrors 91 and 92 have anamorphic surfaces, and, in FIG. 5D, both the two mirrors 91 and 92 have Zernike polynomial surfaces.

Curved surfaces (aspherical shape) (A), (B), (C), and (D) in the respective mirrors can be represented as indicated by expressions described below.

The curved surface (A) of the conic aspherical surface in FIG. 5A is represented by the following expression:

$$Z ( x , y ) = C \cdot ( {x}^{2} + {y}^{2} ) / [ 1 + [ 1 - {( 1 + K \cdot {C}^{2} \cdot ( {x}^{2} + {y}^{2} ) )}^{1 / 2} ] + A \cdot {( {x}^{2} + {y}^{2} )}^{2} + B \cdot {( {x}^{2} + {y}^{2} )}^{3} + {C ( {x}^{2} + {y}^{2} )}^{4} + {D ( {x}^{2} + {y}^{2} )}^{5} + E \cdot {( {x}^{2} + {y}^{2} )}^{6} + F \cdot {( {x}^{2} + {y}^{2} )}^{7} + G \cdot {( {x}^{2} + {y}^{2} )}^{8} + H \cdot {( {x}^{2} + {y}^{2} )}^{9} + J \cdot {( {x}^{2} + {y}^{2} )}^{10} \qquad ( A )$$

(where, C=1/R (R is a radius of curvature), A to J are constants, and K is a conic constant).

The curved surface (B) of the toroidal surface in FIG. 5B is represented by the following expression:

$$Z ( y ) = {C}_{y} {y}^{2} / [ 1 + {[ 1 - ( 1 + {c}_{1} ) \cdot {C}_{y}^{2} \cdot {y}^{2} ]}^{1 / 2} ] + {c}_{2} \cdot {y}^{4} + {c}_{3} \cdot {y}^{6} + {c}_{4} \cdot {y}^{8} + {c}_{5} \cdot {y}^{10} \qquad ( B )$$

(a yz section) (the curved surface is rotated around an axis shifted in the x axis direction by Rₓ in parallel to the y axis to form a curved surface)
(where, C_{y}=1/R_{y} (R_{y} is a radius of curvature of the yz section), and cₖ is a constant).

The curved surface (C) of the anamorphic surface in FIG. 5C is represented by the following expression:

$$Z ( x , y ) = ( {C}_{x} {x}^{2} + {C}_{y} {y}^{2} ) / [ 1 + {[ 1 - ( 1 + {k}_{x} ) \cdot {( {C}_{x} x )}^{2} - ( 1 + {k}_{y} ) \cdot {( {C}_{y} y )}^{2} ]}^{1 / 2} ] + AR \cdot {[ ( 1 - AP ) \cdot {x}^{2} + ( 1 + AP ) \cdot {y}^{2} ]}^{2} + BR \cdot {[ ( 1 - BP ) \cdot {x}^{2} + ( 1 + BP ) \cdot {y}^{2} ]}^{3} + CR \cdot {[ ( 1 - CP ) \cdot {x}^{2} + ( 1 + CP ) \cdot {y}^{2} ]}^{4} + DR \cdot {[ ( 1 - DP ) \cdot {x}^{2} + ( 1 + DP ) \cdot {y}^{2} ]}^{5} \qquad ( C )$$

(where, Cₓ=1/Rₓ (Rₓ and R_{y} are respectively radiuses of curvature on xz and yz sections), and kₓ, k_{y}, AR, BR, CR, DR, AP, BP, CP, and DP are constants).

The curved surface (D) of the Zernike polynomial surface in FIG. 5D is represented by the following expression:

$$Z ( x , y ) = C \cdot ( {x}^{2} + {y}^{2} ) / [ 1 + {[ 1 - ( 1 + {c}_{1} ) \cdot {C}^{2} \cdot ( {x}^{2} + {y}^{2} ) ]}^{1 / 2} ] + {c}_{5} \cdot ( {x}^{2} - {y}^{2} ) + {c}_{6} \cdot ( - 1 + 2 {x}^{2} + 2 {y}^{2} ) + {c}_{10} \cdot ( - 2 y + 3 {x}^{3} y + 3 {y}^{3} ) + {c}_{11} \cdot ( 3 {x}^{2} y - {y}^{3} ) + {c}_{12} \cdot ( {x}^{4} - 6 {x}^{2} {y}^{2} + {y}^{4} ) + {c}_{13} \cdot ( - 3 {x}^{2} + 4 {x}^{4} + 3 {y}^{2} - 4 {y}^{4} ) + {c}_{14} \cdot ( 1 - 6 {x}^{2} + 6 {x}^{4} - 6 {y}^{2} + 12 {x}^{2} {y}^{2} + 6 {y}^{4} ) + {c}_{20} \cdot ( 3 y - 12 {x}^{2} y + 10 {x}^{4} y - 12 {y}^{3} + 20 {x}^{2} {y}^{3} + 10 {y}^{5} ) + {c}_{21} \cdot ( - 12 {x}^{2} y + 15 {x}^{4} y + 4 {y}^{3} + 10 {x}^{2} {y}^{3} - 5 {y}^{5} ) + {c}_{22} \cdot ( 5 {x}^{4} y - 12 {x}^{2} {y}^{3} + 5 {y}^{5} ) + {c}_{23} \cdot ( {x}^{6} - 15 {x}^{4} {y}^{2} + 15 {x}^{2} {y}^{4} - {y}^{6} ) + {c}_{24} \cdot ( 6 {x}^{6} - 5 {x}^{4} - 30 {x}^{4} {y}^{2} - 30 {x}^{2} y + 30 {x}^{2} {y}^{2} + 6 {y}^{6} - 5 {y}^{4} ) + {c}_{25} \cdot ( 30 {x}^{5} y + 60 {x}^{3} {y}^{3} + 30 {xy}^{5} - 40 {x}^{3} y - 40 {xy}^{3} + 12 xy ) + {c}_{26} \cdot ( 20 {x}^{6} + 60 {x}^{4} {y}^{2} + 60 {x}^{2} {y}^{4} + 20 {y}^{6} - 30 {x}^{4} - 60 {x}^{2} {y}^{2} - 30 {y}^{4} + 2 {x}^{2} + 12 {y}^{2} - 1 ) \qquad ( D )$$

(where, C=1/R (R is a radius of curvature) and ck is a constant).

z represents a reference beam (a center angle of view beam) direction that is a beam propagating direction and x and y represent directions perpendicular to z.

According to the expressions, (A) is about 0.9 λ in a PV value and a Strehl ratio is about 0.2. Therefore, correction is evidently insufficient. (B) is about 0.5 λ a wavefront aberration PV value and a Strehl ratio is about 0.7. Therefore, aberration cannot be reduced to a desired aberration amount.

On the other hand, (C) is about 0.3 λ in a wavefront aberration PV value and a Strehl ratio is about 0.87. Therefore, the desired aberration amount can be substantially satisfied.

(D) is about 0.2 λ in a wavefront aberration PV value and a Strehl ratio is about 0.97. Therefore, it is possible to suppress aberration to a satisfactory level close to no aberration.

However, the above example is an example in which a plurality of beams is arranged and an angle of view is given to the beams only in a decentered section (a yz surface). If an angle of view is also given in a direction perpendicular to the decentered section (an x direction), aberration of the beams is further deteriorated.

In that case, it is difficult to sufficiently suppress aberration even in the anamorphic surface of (C) that has symmetrical shapes both in the x and y directions. It is essential to use the Zernike polynomial surface of (D).

It is also possible to attain the aberration level when the Zernike polynomial surface of (D) is adopted for only one of the two mirrors and the other is formed as a spherical surface.

In the adaptive optics for an eyeball or the like in which a plurality of thick beams is formed by the common relay optical system, as a decentered curved surface mirror, the use of an aspherical mirror not having a rotation axis of symmetry is indispensable.

Optical data obtained when the Zernike polynomial surface (D) is actually used for the curved surface mirrors 91 and 92 is shown in Table 1.

A pupil magnification is set to 0.5, the focal length of the mirror 91 is set to about 150 mm, and the focal length of the mirror 92 is set to about 75 mm.

A surface number 1 indicates a deflector, a surface number 3 indicates the curved surface mirror 91, a surface number 6 indicates the curved surface mirror 91, and a surface number 8 indicates a wavefront aberration correcting device. A unit of distance is mm and a unit of angle is degree.

TABLE 1

| Surface Number | Radius of Curvature | Surface Interval | |
|---|---|---|---|
| Object Point: | INFINITY | INFINITY | |
| 1: | INFINITY | 0.000000 | (Pupil) |
| 2: | INFINITY | 150.000000 | |
| 3: | −296.62394 | 0.000000 | (Reflection) |

Non-rotational symmetrical aspherical surface:

| | | | |
|---|---|---|---|
| C1: | 5.4773E+00 | (Conic constant) | |
| C5: | −2.9943E−06 | | |
| C6: | 1.0438E−05 | | |
| C10: | 1.1389E−07 | | |
| C11: | 1.5810E−07 | | |
| C12: | −6.1191E−09 | | |
| C13: | −7.5139E−09 | | |
| C14: | 1.1204E−09 | | |
| C20: | −3.9394E−10 | | |
| C21: | −9.2789E−10 | | |
| C22: | −1.4791E−09 | | |
| C23: | −4.9401E−11 | | |
| C24: | −3.6623E−11 | | |
| C25: | −3.2051E−11 | | |
| C26: | −1.6234E−11 | | |
| XDE: | 0.000000 | YDE: | 0.049733 |
| ZDE: | 0.000000 | ADE: | 3.802393 |
| BDE: | 0.000000 | CDE: | 0.000000 |
| 4: | INFINITY | −150.000000 | |
| XDE: | 0.000000 | YDE: | 0.034587 |
| ZDE: | 0.000000 | ADE: | 3.365910 |
| BDE: | 0.000000 | CDE: | 0.000000 |
| 5: | INFINITY | −75.000000 | |
| 6: | 146.77123 | 0.000000 | (Reflection) |

Non-rotational symmetrical aspherical surface:

| | | | |
|---|---|---|---|
| C1: | −5.1654E+01 | (Conic constant) | |
| C5: | 1.5609E−05 | | |
| C6: | −3.6064E−05 | | |
| C10: | −1.3581E−07 | | |
| C11: | 1.1730E−06 | | |
| C12: | −2.9456E−07 | | |
| C13: | −2.5802E−07 | | |
| C14: | 2.2564E−07 | | |
| C20: | −4.1892E−09 | | |
| C21: | −1.4918E−08 | | |
| C22: | −2.2653E−08 | | |
| C23: | −2.6380E−10 | | |
| C24: | 1.0643E−12 | | |
| C25: | 5.8311E−11 | | |
| C26: | −4.8455E−11 | | |
| XDE: | 0.000000 | YDE: | 0.160798 |
| ZDE: | 0.000000 | ADE: | −3.801431 |
| BDE: | 0.000000 | CDE: | 0.000000 |
| 7: | INFINITY | 75.000000 | |
| XDE: | 0.000000 | YDE: | −0.011475 |
| ZDE: | 0.000000 | ADE: | −4.211016 |
| BDE: | 0.000000 | CDE: | 0.000000 |
| 8: | INFINITY | 0.000000 | |
| XDE: | 0.000000 | YDE: | 0.000000 |
| ZDE: | 0.000000 | ADE: | 3.429743 |
| BDE: | 0.000000 | CDE: | 0.000000 |
| 9: | INFINITY | 0.000000 | |
| XDE: | 0.000000 | YDE: | −0.002089 |
| ZDE: | 0.000000 | ADE: | 0.000000 |
| BDE: | 0.000000 | CDE: | 0.000000 |

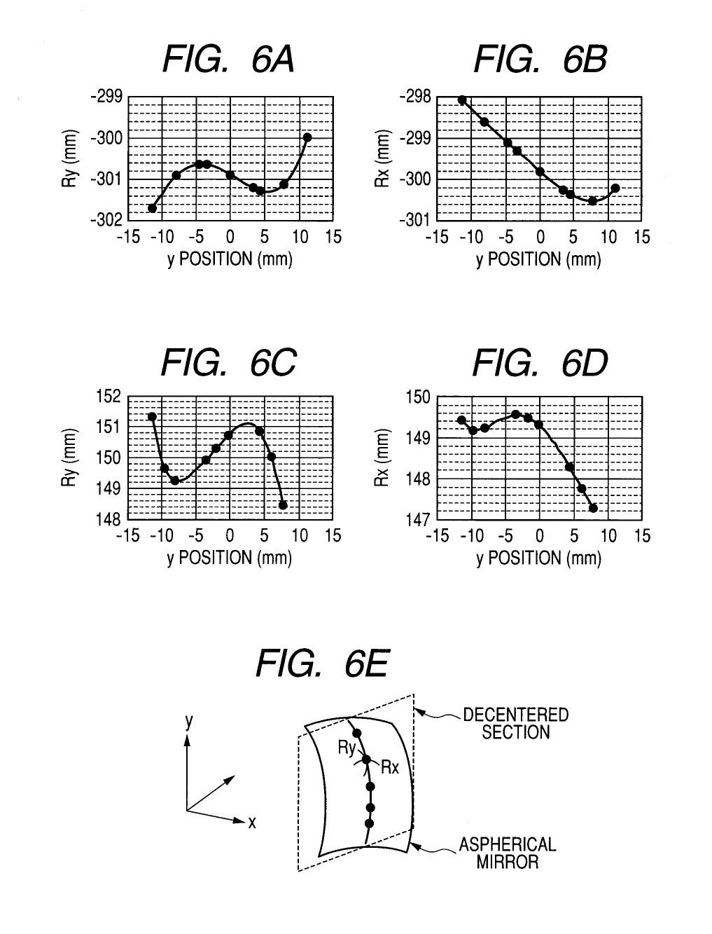

In mirror 91, values of y direction components R_{y} (components in a decentered sectional direction) of local radius of curvature at points on a nodal line with a decentered section (a surface perpendicular to a decentered rotation axis/a yz surface) shown in FIG. 6E are illustrated in FIG. 6A and values of x direction components Rₓ (components in a direction perpendicular to the decentered section) are illustrated in FIG. 6B.

Similarly, in the mirror 92, values of y direction components R_{y} (components in a decentered sectional direction) of a local radius of curvature at points on a nodal line with a decentered section shown in FIG. 6E are illustrated in FIG. 6C and values of x direction components Rₓ (components in a direction perpendicular to the decentered section) are illustrated in FIG. 6D.

According to the figures, with respect to a y coordinate on the nodal line, for the mirror 91, n_{y} as the number of inflection points of a y component of a radius of curvature is 2 and nₓ as the number of inflection points of an x component is 1. For the mirror 92, n_{y} is 2 and nₓ is 2.

The above description is about the numbers of inflection points obtained when the pupil magnification is 0.5. However, when other magnifications are adopted, when an aspherical surface is used only for one of the two mirrors and the other is a spherical surface, and when an angle of view is given in a direction perpendicular to the yz surface (an x direction), the number of inflection points are always as described below.

Specifically, when optimization of a mirror shape is performed to reduce aberration, the numbers nₓ and n_{y} of inflection points are as shown in Table 2. A relation between the numbers nₓ and n_{y} is always n_{y}≧nₓ. nₓ is not larger than n_{y}.

TABLE 2

| Number of | Pupil | Mirror 91 | | | Mirror 92 | | |
|---|---|---|---|---|---|---|---|
| Beams | Magnification | Shape | n_{y} | nₓ | Shape | n_{y} | nₓ |
| 3 | 0.5 | Aspherical | 2 | 1 | Aspherical | 2 | 2 |
| (only in the | 1.0 | | 3 | 1 | | 4 | 2 |
| yz surface) | 2.0 | | 2 | 2 | | 4 | 2 |
| | 0.5 | Spherical | — | — | Aspherical | 3 | 2 |
| | 1.0 | | — | — | | 4 | 3 |
| | 2.0 | | — | — | | 3 | 1 |
| | 0.5 | Aspherical | 3 | 3 | Spherical | — | — |
| | 1.0 | | 4 | 2 | | — | — |
| | 2.0 | | 2 | 2 | | — | — |
| 9 | 0.5 | Aspherical | 3 | 0 | Aspherical | 2 | 0 |
| (3 in the y | 1.0 | | 3 | 1 | | 2 | 1 |
| direction × | 2.0 | | 3 | 0 | | 4 | 3 |
| 3 in the x | | | | | | | |
| direction) | | | | | | | |

It is necessary to make a plurality of collimated beams incident on the wavefront aberration correcting device at different angles. As a method therefor, as illustrated in FIG. 3A, a plurality of divergent beam emission ends 11, 12, and 13 is arranged at distances from one another on a surface perpendicular to an optical axis on a front side focal position (the xy surface) of the collimator optical system 90. The divergent beam emission ends 11, 12, and 13 are arranged such that principal rays of the respective emission beams are parallel to the optical axis of the collimator optical system 90.

The beams form an exit pupil 61 in a rear side focal position of the collimator optical system 90. Therefore, the wavefront aberration correcting device 3 may be arranged in a position optically conjugate with the exit pupil position 61.

Consequently, it is possible to make a plurality of collimated beams incident on the same position at different angles by the common optical system 901.

As the optical system 901, like the optical system between the deflector and the wavefront aberration correcting device, the aspherical mirror having the shape described above may be used in order to suppress aberration.

As another method, aberration may also be suppressed as illustrated in FIG. 3B.

Specifically, a plurality of collimator optical systems 911, 912, and 913 respectively corresponding to a plurality of divergent beam emission ends is set and beams made collimated by the collimator optical systems are crossed at one point in a position 611 at a predetermined angle.

The wavefront aberration correcting device 3 is arranged in a position of an exit pupil 31 formed by a relay optical system 901 having the position as an incident pupil.

In order to perform correction of a wavefront, it is necessary to arrange the wavefront aberration detecting device in a position optically conjugate with the wavefront aberration correcting device.

This is because it is possible to directly use data of a detected wavefront for correction value calculation. Meanwhile, when the wavefront aberration detecting device is optically conjugate with the wavefront aberration correcting device, a plurality of beams is also made incident on the wavefront aberration detecting device at different angles.

In this case, in the detecting device of the system shown in FIG. 2B, a large number of spots are formed on an imaging device. Therefore, it cannot be distinguished which spot is formed by which beam and a wavefront cannot be correctly detected.

Wavefront aberration correction is performed by a single wavefront aberration correcting device. Therefore, data of wavefronts of a plurality of beams is unnecessary. Any one of the beams may be detected.

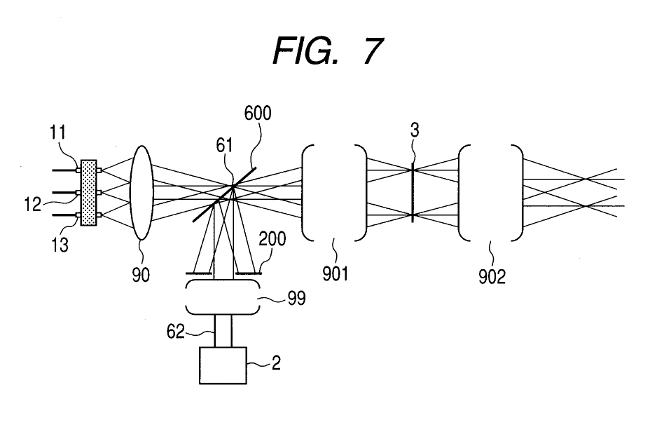

Therefore, as shown in FIG. 7, a configuration for splitting a signal beam between the collimator optical system 90 and the optical system 901 and blocking beams other than detected beams is adopted.

If effective diameters of the pupil 61 and the wavefront aberration detecting device 2 are equivalent, the signal beam may be split in a position between the pupil 61 and the optical system 901 and the wavefront aberration detecting device 2 may be set in a position equivalent to the pupil 61. When the effective diameters of the pupil 61 and the wavefront aberration detecting device 2 are not equivalent, a relay optical system 99 may be configured again to build a pupil conjugate position 62.

In this case, since return beam from any one of optical surfaces of the relay optical system 99 does not occur, it is unnecessary to form the relay optical system and a decentered reflecting optical system. It is possible to configure the relay optical system with a rotational symmetrical lens.

If the aspherical mirror having the shape described above is used, even in a system for simultaneously scanning a plurality of beams, it is possible to obtain a satisfactory image with a high S/N ratio at high speed using a single wavefront aberration correcting device and a single wavefront aberration detecting device.

In the above description, a plurality of beams is used. However, in the case of an adaptive optics using a single beam, if the non-rotational symmetrical aspherical mirror described above is used, it is possible to reduce aberration even at a short focal length compared with the reduction in aberration realized when one of the spherical mirror and the rotational symmetrical aspherical mirror is used.

Therefore, even in the case of the adaptive optics using the single beam, it is possible to substantially reduce the size of the optical system.

### EXAMPLE 1

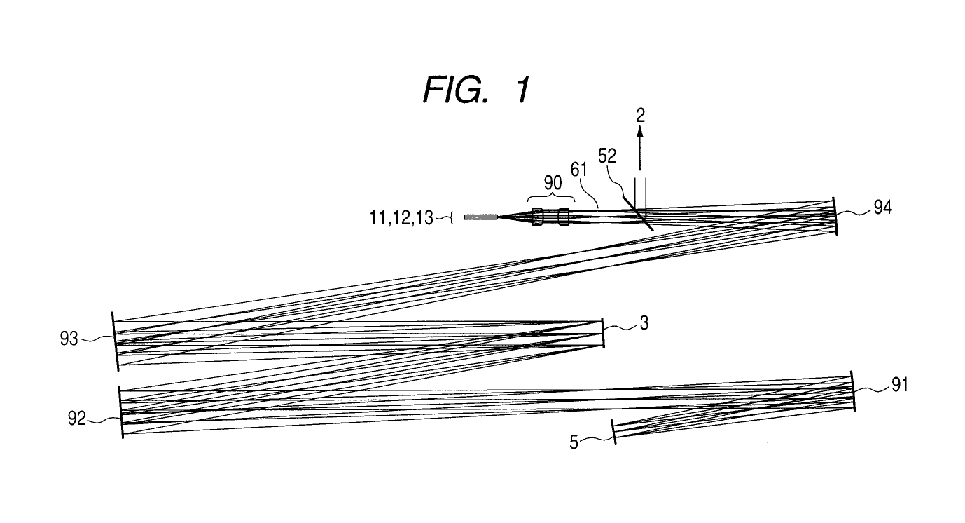

A main part of an image acquisition apparatus including an adaptive optics in Example 1 to which the present invention is applied is described using FIG. 1.

In FIG. 1, a wavefront aberration correcting device (DM) 3 and a beam emission ends 11, 12, and 13, which correspond to the fiber end A described in FIG. 2A, are provided.

A deflector 5, an exit pupil 61 of a collimator optical system, a collimator optical system 90, and aspherical mirrors aspherical mirror 91, 92, 93 and 94 are provided.

Light from a low-coherent light source for such as one of an SLO and an OCT propagates through three optical fibers. The light is emitted as divergent beams respectively from the emission ends 11, 12, and 13 arranged at a distance of 1 mm from one another in a decentered section (a paper surface) and collimated by the collimator optical system 90. A beam diameter (relative intensity 1/e²) at this point is φ7.4 mm.

collimated three beams pass through the exit pupil 61. After passing through the exit pupil 61, the beams are made incident on a reflection surface of the DM 3, which is a surface optically conjugate with the pupil 61, in a state of collimated beams at different angles by a relay optical system formed by the aspherical mirrors 94 and 93 and overlapped on the DM surface.

The diameter of the beams at this point is φ15 mm, which is a value slightly smaller than an effective diameter of the DM 3. The beams reflected on the reflection surface are made incident on the deflector 5 at different angles via the aspherical mirrors 92 and 91.

The beams deflected by the deflector 5 are made incident on a pupil of an eye to be inspected in a state of substantially collimated beams by a not-shown scanning optical system, condensed on a retina, and two-dimensionally scanned.

Since wavefronts are disordered by aberration of the eyeball, beam spots at this point have a disordered and spread shape.

Reflected/scattered beams from three spots condensed on the retina are emitted from the pupil of the eyeball and reversely propagate from the scanning optical system via the aspherical mirrors 91 and 92. A part of the reflected/scattered beams is reflected and made incident on the not-shown wavefront aberration detecting device (HS sensor) 2. A correction signal to the DM 3 is calculated from a measurement value in the HS sensor by a not-shown computer and sent to the DM 3. According to the signal, The DM 3 is deformed into a shape for correcting wavefront aberration.

Consequently, the wavefronts of the beams from the beam emission ends 11, 12, and 13 are converted. The spots on the retina are corrected to a state close to the diffraction limit.

The reflected/scattered beams from the spots cause wavefront aberration again when the reflected/scattered beams pass the ocular optical system. However, the disordered wavefronts are corrected by the DM 3 again.

The reflected/scattered beams, via the aspherical mirrors 93 and 94 and the collimator optical system 90, are respectively satisfactorily focused on the emission ends 11, 12, and 13 of the fibers and made incident on the fibers at high coupling efficiency.

In the case of the OCT, the beams propagating through the fibers are combined with a reference beam propagating through a reference light path to obtain interference beam. An interference signal of the interference beam is subjected to Fourier transform, whereby the interference signal is calculated as reflectance distribution in the depth direction of the retina. If the beams are one-dimensionally scanned, an image of a section is obtained.

It is also possible to obtain a three-dimensional image by two-dimensionally scanning the beams.

As for SLO, since it does not include an interferometer unlike the OCT, light intensity of reflected/scattered beam from the retina is directly detected by a light intensity detecting device. In the case of image acquisition by the SLO, fiber propagation light intensity is associated with two-dimensional scanning positions of the beams and a fundus image by a two-dimensional image is obtained.

Since the three beams are used, it is possible to perform measurement at triple speed compared with the scanning of one beam and secure high resolution in the horizontal direction.

Optical data of the adaptive optics illustrated in FIG. 1 is shown in Table 3.

Wavelength is set to 840 mm.

A rotational symmetrical aspherical surface conforms to a function form of (A) described above.

TABLE 3

| | | Surface | | |
|---|---|---|---|---|
| Surface Number | Radius of Curvature | Interval | Index of Refraction | Dispersion |
| Object Point: | INFINITY | 14.916907 | | |
| 1: | −307.19070 | 6.363409 | 1.487490 | 70.1100 |

Rotational symmetrical aspherical surface:

K: 7193.761976

| | | | |
|---|---|---|---|
| A: −.221207E−03 | B: −.162000E−05 | C: 0.420000E−07 | D: 0.173000E−07 |
| E: 0.229000E−08 | F: 0.102000E−09 | G: 0.793000E−12 | H: −.777000E−12 |
| J: −.848000E−13 | | | |

| | | |
|---|---|---|
| 2: | −14.46573 | 9.710049 |

Rotational symmetrical aspherical surface:

| | | | |
|---|---|---|---|
| K: 1.156659 | | | |
| A: −.626000E−04 | B: −.107000E−05 | C: 0.491000E−07 | D: 0.328000E−08 |
| E: 0.117000E−09 | F: 0.183000E−11 | G: −.147000E−12 | H: −.192000E−13 |
| J: −.144000E−14 | | | |

| | | | | |
|---|---|---|---|---|
| 3: | 547.42835 | 6.000000 | 1.487490 | 70.1100 |

Rotational symmetrical aspherical surface:

| | | | |
|---|---|---|---|
| K: 14084.666030 | | | |
| A: 0.373000E−04 | B: 0.663000E−06 | C: 0.583000E−08 | D: −.446000E−09 |
| E: −.349000E−10 | F: −.144000E−11 | G: −.370000E−13 | H: −.190000E−15 |
| J: 0.529000E−16 | | | |

| | | |
|---|---|---|
| 4: | −32.71076 | 15.000000 |

Rotational symmetrical aspherical surface:

| | | | |
|---|---|---|---|
| K: −7.907633 | | | |
| A: 0.257000E−04 | B: 0.883000E−06 | C: 0.456000E−08 | D: −.453000E−09 |
| E: −.208000E−10 | F: −.495000E−12 | G: −.870000E−15 | H: 0.781000E−15 |
| J: 0.642000E−16 | | | |

| | | | |
|---|---|---|---|
| 5: | INFINITY | 0.000000 | (Stop) |
| 6: | INFINITY | 150.000000 | |
| 7: | −298.54427 | 0.000000 | (Reflection) |

Non-rotational symmetrical surface:

| | | |
|---|---|---|
| C1: | 2.3944E+00 | (Conic constant) |
| C5: | −1.5988E−06 | |
| C6: | 7.8209E−06 | |
| C10: | −8.6855E−08 | |
| C11: | 2.9768E−07 | |
| C12: | 6.5207E−09 | |
| C13: | 9.7596E−09 | |
| C14: | −6.8020E−10 | |
| C20: | −8.5954E−11 | |
| C21: | −7.3132E−10 | |
| C22: | −1.3299E−09 | |
| C23: | −2.6034E−11 | |
| C24: | −1.2802E−11 | |
| C25: | −7.4629E−12 | |
| C26: | 5.1691E−12 | |

| | | | | | |
|---|---|---|---|---|---|
| X direction shift: | 0.000000 | Y direction shift: | 0.093405 | Z direction shift: | 0.000000 |
| X axis rotation | 5.094800 | Y axis rotation | 0.000000 | Z axis rotation | 0.000000 |

| | | |
|---|---|---|
| 8: | INFINITY | −150.000000 |

| | | | | | |
|---|---|---|---|---|---|
| X direction shift: | 0.000000 | Y direction shift: | 0.721197 | Z direction shift: | 0.000000 |
| X axis rotation | 4.294999 | Y axis rotation | 0.000000 | Z axis rotation | 0.000000 |

| | | | |
|---|---|---|---|
| 9: | INFINITY | −300.000000 | |
| 10: | 593.30764 | 0.000000 | (Reflection) |

Non-rotational symmetrical surface:

| | | |
|---|---|---|
| C1: | 9.9606E+00 | (Conic constant) |
| C5: | 7.4375E−06 | |
| C6: | −6.1047E−06 | |
| C10: | −3.6367E−09 | |
| C11: | 3.0027E−08 | |
| C12: | 4.5199E−09 | |
| C13: | −4.8348E−09 | |
| C14: | −1.0100E−09 | |
| C20: | 1.0463E−10 | |
| C21: | −1.3750E−10 | |
| C22: | 2.0446E−10 | |
| C23: | −3.3918E−12 | |
| C24: | 3.1433E−12 | |
| C25: | 2.2235E−12 | |
| C26: | 2.6900E−12 | |

| | | | | | |
|---|---|---|---|---|---|
| X direction shift: | 0.000000 | Y direction shift: | −0.044923 | Z direction shift: | 0.000000 |
| X axis rotation | −4.279259 | Y axis rotation | 0.000000 | Z axis rotation | 0.000000 |

| | | |
|---|---|---|
| 11: | INFINITY | 300.000000 |

| | | | | | |
|---|---|---|---|---|---|
| X direction shift: | 0.000000 | Y direction shift: | 0.186444 | Z direction shift: | 0.000000 |
| X axis rotation | −3.135714 | Y axis rotation | 0.000000 | Z axis rotation | 0.000000 |

| | | | |
|---|---|---|---|
| 12: | INFINITY | 0.000000 | (DM) |

| | | | | | |
|---|---|---|---|---|---|
| X direction shift: | 0.000000 | Y direction shift: | −10.274897 | Z direction shift: | 0.000000 |
| X axis rotation | 3.500000 | Y axis rotation | 0.000000 | Z axis rotation | 0.000000 |

| | | |
|---|---|---|
| 13: | INFINITY | −300.000000 |

| | | | | | |
|---|---|---|---|---|---|
| X direction shift: | 0.000000 | Y direction shift: | 0.000000 | Z direction shift: | 0.000000 |
| X axis rotation | 3.500000 | Y axis rotation | 0.000000 | Z axis rotation | 0.000000 |

| | | | |
|---|---|---|---|
| 14: | INFINITY | 0.000000 | |
| 15: | 601.03850 | 0.000000 | (Reflection) |

Non-rotational symmetrical surface

| | | |
|---|---|---|
| C1: | 4.5290E+02 | (Conic constant) |
| C5: | −4.8771E−05 | |
| C6: | −2.3725E−05 | |
| C10: | 1.0451E−07 | |
| C11: | −1.1161E−07 | |
| C12: | −9.3827E−09 | |
| C13: | −1.4555E−08 | |
| C14: | −4.7655E−08 | |
| C20: | −5.1303E−11 | |
| C21: | 1.4204E−10 | |
| C22: | 1.6861E−10 | |
| C23: | 3.5184E−10 | |
| C24: | 3.5101E−10 | |
| C25: | 3.5930E−10 | |
| C26: | 1.6607E−10 | |

| | | | | | |
|---|---|---|---|---|---|
| X direction shift: | 0.000000 | Y direction shift: | −2.294906 | Z direction shift: | 0.000000 |
| X axis rotation | −3.434312 | Y axis rotation | 0.000000 | Z axis rotation | 0.000000 |

| | | |
|---|---|---|
| 16: | INFINITY | 300.000000 |

| | | | | | |
|---|---|---|---|---|---|
| X direction shift: | 0.000000 | Y direction shift: | 3.645262 | Z direction shift: | 0.000000 |
| X axis rotation | −4.029596 | Y axis rotation | 0.000000 | Z axis rotation | 0.000000 |

| | | | |
|---|---|---|---|
| 17: | INFINITY | 150.000000 | |
| 18: | −236.97893 | 0.000000 | (Reflection) |

Non-rotational symmetrical surface

| | | |
|---|---|---|
| C1: | −4.3596E+02 | (Conic constant) |
| C5: | −3.2016E−04 | |
| C6: | 5.2630E−05 | |
| C10: | 4.3892E−07 | |
| C11: | 4.4943E−07 | |
| C12: | 3.4646E−06 | |
| C13: | 3.4671E−06 | |
| C14: | 1.1511E−06 | |
| C20: | −3.3945E−09 | |
| C21: | −7.5691E−09 | |
| C22: | −8.2064E−09 | |
| C23: | 1.1274E−09 | |
| C24: | 6.9640E−10 | |
| C25: | 3.6087E−10 | |
| C26: | 4.1429E−10 | |

| | | | | | |
|---|---|---|---|---|---|
| X direction shift: | 0.000000 | Y direction shift: | −1.929593 | Z direction shift: | 0.000000 |
| X axis rotation | 4.317149 | Y axis rotation | 0.000000 | Z axis rotation | 0.000000 |

| | | |
|---|---|---|
| 19: | INFINITY | −150.000000 |

| | | | | | |
|---|---|---|---|---|---|
| X direction shift: | 0.000000 | Y direction shift: | 0.789544 | Z direction shift: | 0.000000 |
| X axis rotation | 4.281263 | Y axis rotation | 0.000000 | Z axis rotation | 0.000000 |

| | | | |
|---|---|---|---|
| 20: | INFINITY | 0.000000 | (Deflector surface) |

### EXAMPLE 2

Example 1 is an example in which the three beam emission ends are arranged in the decentered section (the yz surface). However, it is possible to simultaneously scan a larger number of beams and increase speed of image acquisition by arranging an emission end in the x axis direction as well.

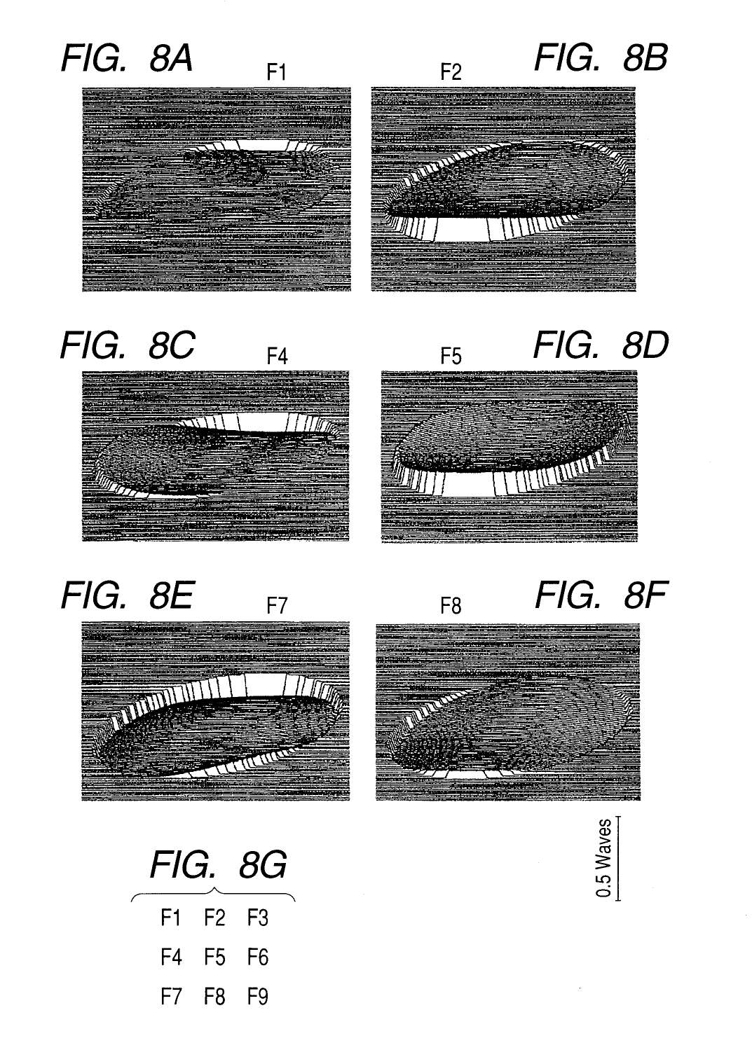

Design data of an optical system in which nine (3×3) emission ends are arranged in a lattice shape on an xy surface is shown in Table 4. An angle of view x in a pupil is set to ±3 degrees in both x and y direction sections, a pupil diameter is set to φ6.7 mm, and wavelength is set to 840 nm. Wavefront aberrations of beams are illustrated in FIGS. 8A, 8B, 8C, 8D, 8E, and 8F. However, since the wavefront aberrations of the left line and the right line of FIG. 8G are symmetrical, characteristics of F3, F6, and F9 among angle of view positions illustrated in FIG. 8G are omitted. All the wavefront aberrations are around 0.9 in a Strehl ratio.

TABLE 4

| Surface Number | Radius of Curvature | Surface Interval | |
|---|---|---|---|
| Object Point: | INFINITY | INFINITY | |
| 1: | INFINITY | 0.000000 | (Deflector Surface) |
| 2: | INFINITY | 150.000000 | |
| 3: | −302.29306 | 0.000000 | (Reflection) |

Non-rotational symmetrical aspherical surface

| | | |
|---|---|---|
| C1: | 1.3091E+02 | (Conic constant) |
| C5: | −3.3394E−06 | |
| C6: | −5.4077E−06 | |
| C10: | 1.6995E−08 | |
| C11: | 1.2760E−07 | |
| C12: | −5.7904E−09 | |
| C13: | −1.4582E−09 | |
| C14: | 9.3040E−08 | |
| C20: | 8.0343E−12 | |
| C21: | −2.8885E−11 | |
| C22: | 6.1957E−11 | |
| C23: | 2.8524E−12 | |
| C24: | 3.5282E−12 | |
| C25: | 1.9921E−12 | |
| C26: | 3.4253E−11 | |

| | | | | | |
|---|---|---|---|---|---|
| X direction shift: | 0.000000 | Y direction shift: | 0.019548 | Z direction shift: | 0.000000 |
| X axis rotation | 3.530555 | Y axis rotation | 0.000000 | Z axis rotation | 0.000000 |

| | | |
|---|---|---|
| 4: | INFINITY | −150.000000 |

| | | | | | |
|---|---|---|---|---|---|
| X direction shift: | 0.000000 | Y direction shift: | −6.050630 | Z direction shift: | 0.000000 |
| X axis rotation | 3.337894 | Y axis rotation | 0.000000 | Z axis rotation | 0.000000 |

| | | |
|---|---|---|
| 5: | INFINITY | −150.000000 |

| | | | |
|---|---|---|---|
| 6: | 292.44633 | 0.000000 | (Reflection) |

Non-rotational symmetrical aspherical surface

| | | |
|---|---|---|
| C1: | −1.3916E+02 | (Conic constant) |
| C5: | 3.1179E−06 | |
| C6: | −2.1108E−05 | |
| C10: | 9.9445E−09 | |
| C11: | 1.2770E−07 | |
| C12: | 5.8521E−09 | |
| C13: | 5.4978E−10 | |
| C14: | 1.1321E−07 | |
| C20: | 8.2935E−12 | |
| C21: | −2.5849E−11 | |
| C22: | 3.4573E−11 | |
| C23: | −2.3893E−13 | |
| C24: | −6.9369E−12 | |
| C25: | −8.0405E−13 | |
| C26: | −2.0566E−11 | |

| | | | | | |
|---|---|---|---|---|---|
| X direction shift: | 0.000000 | Y direction shift: | 5.123694 | Z direction shift: | 0.000000 |
| X axis rotation | −3.607686 | Y axis rotation | 0.000000 | Z axis rotation | 0.000000 |

| | | |
|---|---|---|
| 7: | INFINITY | 150.000000 |

| | | | | | |
|---|---|---|---|---|---|
| X direction shift: | 0.000000 | Y direction shift: | 0.190151 | Z direction shift: | 0.000000 |
| X axis rotation | −3.865251 | Y axis rotation | 0.000000 | Z axis rotation | 0.000000 |

| | | |
|---|---|---|
| 8: | INFINITY | 0.000000 |

| | | | | | |
|---|---|---|---|---|---|
| X direction shift: | 0.000000 | Y direction shift: | 0.000000 | Z direction shift: | 0.000000 |
| X axis rotation | 2.100470 | Y axis rotation | 0.000000 | Z axis rotation | 0.000000 |

| | | | |
|---|---|---|---|
| 9: | INFINITY | 0.000000 | (DM surface) |

| | | | | | |
|---|---|---|---|---|---|
| X direction shift: | 0.000000 | Y direction shift: | 0.000000 | Z direction shift: | 0.000000 |
| X axis rotation | 0.000000 | Y axis rotation | 0.000000 | Z axis rotation | 0.000000 |

### EXAMPLE 3

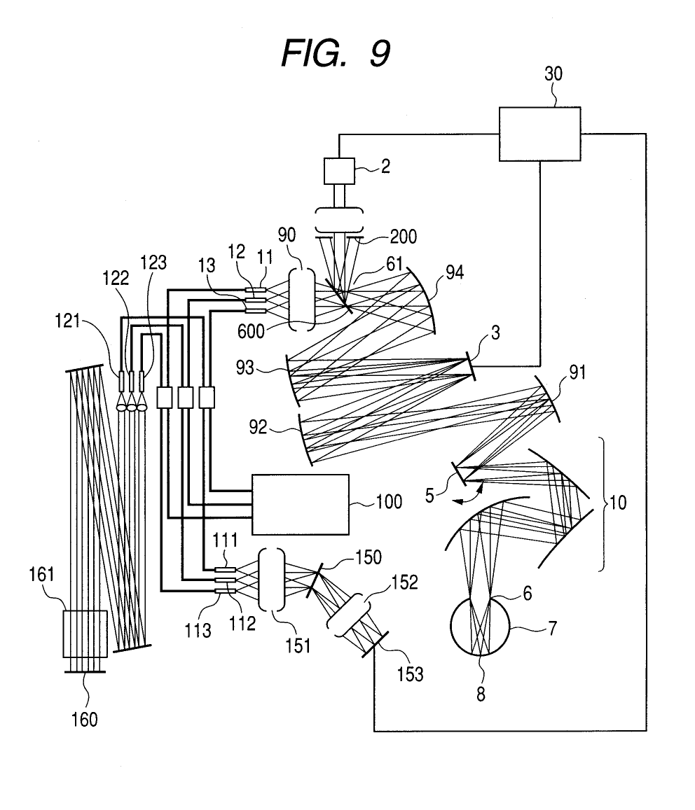

In Example 3, a configuration example in which the adaptive optics of the present invention described above is applied to an OCT capable of acquiring a three-dimensional tomographic image is described with reference to FIG. 9.

Light from a low-coherent light source 100 propagates through an optical fiber and is split at a predetermined ratio in a fiber coupler, then emitted as divergent beams respectively from the emission ends 11,12 and 13, and collimated by the collimator optical system 90.

Collimated three beams pass through the exit pupil 61. After passing through the exit pupil 61, the beams are made incident on the DM 3, which is a surface optically conjugate with the exit pupil 61 and the pupil 6 of the eye to be inspected, in a state of collimated beams at different angles by the aspherical mirrors 94 and 93 and superimposed on the DM 3 surface.

The diameter of the beams at this point is φ10 mm, which is slightly smaller than an effective diameter of the DM 3. A correction signal is not sent to the DM 3 at this point. The DM 3 is in a planar shape.

The beams reflected on the DM 3 are collimated by the aspherical mirrors 92 and 91 and made incident on the deflector 5 at different angles.

The beams deflected by the deflector 5 are made incident on the pupil 6 of the eye 7 to be inspected in a state of collimated beams by the scanning optical system 10 and two-dimensionally scanned on the retina 8.

Since wavefronts are disordered by aberration of the eyeball, beam spots at this point have a disordered and spread shape.

Reflected beams or scattered beams from three spots condensed on the retina are emitted from the pupil 6 and reversely propagate from the scanning optical system 10 to the aspherical mirror 94. A part of the reflected beams or scattered beams is reflected by a beam splitting unit 600 and made incident on the HS sensor 2.

At this point, reflected/scattered beam from the retina by the beam from the beam emission end 12 is made incident on the HS sensor. Reflected beams or scattered beams by the other beams are blocked by a beam blocking unit 200 and are not made incident on the HS sensor 2.

A correction signal to the DM 3 is calculated by the calculating apparatus 30 from a measurement value in the HS sensor and sent to the DM 3.

The DM 3 is deformed into a shape for correcting wavefront aberration according to the signal.

Consequently, the wavefronts of the beams from the beam emission ends 11,12 and 13 are converted. The spots on the retina are corrected to a state close to the diffraction limit.

The diameter of the beams made incident on the pupil 6 is set to about 4 mm and has a spot diameter of a size of about 5 μm on the retina.

Reflected beams and scattered beams from the spots have wavefront aberrations again when the beams pass through the ocular optical system. However, disordered wavefronts are corrected by the DM 3.

Then, the reflected beams and the scattered beams are satisfactorily focused on the emission ends 11,12 and 13 of the fibers via the aspherical mirrors 93 and 94 and the collimator optical system 90, and made incident on the fibers at high coupling efficiency.

On the other hand, similarly, the beam from the light source 100 is split at a predetermined ratio in the fiber coupler, then emitted from emission ends 121, 122, and 123 on a reference arm side, collimated by the collimator optical system, and then made incident on the emission ends 121, 122, and 123 again through a dispersion compensating glass 161 and a return mirror 160.

This reference beam and the reflected beam or the scattered beam from the eyeball are coupled by the fiber coupler and emitted from emission ends 111, 112, and 113 on a spectroscope side.

Emitted divergent beams are collimated by the collimator optical system 151 and then made incident on a diffractive optical element 150 and diffracted. An incident angle is set such that diffraction efficiency of 1^{st} ordered diffracted beam is maximized. The diffracted beams are split for each wavelength and condensed on a detector 153 by a focusing optical system 152. On the detector 153, the beams are focused in different positions in a direction parallel to the paper surface for each wavelength. In the figure, to facilitate understanding, a light beam having only center wavelength is displayed.

The calculating apparatus 30 subjects a signal obtained by the detector 153 to Fourier transform, whereby a relation between a depth position and reflectance is derived. If the beams are one-dimensionally scanned, an image of a section (B-scan image) is obtained. It is also possible to obtain a three-dimensional image by rotating the deflector 5 in an arrow direction and two-dimensionally scanning the retina 8. Since the three beams are used, it is possible to perform measurement at triple speed compared with the scanning of one beam and secure 5 μm as optical resolution in the horizontal direction.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-113774, filed on May 8, 2009, which is hereby incorporated by reference herein in its entirety.

1. An image acquisition apparatus characterized by comprising:
a radiation device for radiating a plurality of measuring beams to each different positions of an object,
one or more wavefront aberration detecting device that detects wavefront aberration in at least one of a plurality of reflected and/or scattered beams from an object; and
a single wavefront aberration correcting device that corrects the wavefront aberration of at least one of the plurality of measuring beams and the plurality of reflected and/or scattered beams using the wavefront aberration detected by the wavefront aberration detecting device, the single wavefront aberration correcting device being arranged in a position optically conjugate with a deflector.

2. An image acquisition apparatus characterized in comprising:
a wavefront aberration detecting device that detects wavefront aberration of a reflected and/or scattered beam from an object;
a wavefront aberration correcting device that corrects the wavefront aberration of at least one of a measuring beam and the reflected and/or scattered beam using the wavefront aberration detected by the wavefront aberration detecting device, the wavefront aberration correcting device being arranged in a position optically conjugate with a deflector; and
at least one aspherical mirror not having a rotation axis of symmetry, the aspherical mirror being arranged between arrangement positions of the wavefront aberration correcting device and the deflector.

3. The image acquisition apparatus according to claim 2, characterized in that
the measuring beam includes a plurality of beams, and
each beam of the plurality of beams is scanned on a different area of the object by the deflector.

4. The image acquisition apparatus according to claim 2, characterized in that, in a nodal line of the aspherical mirror surface with a decentered section that is a plane normal to a decentering rotation axis, when a change in a local radius of curvature of the aspherical mirror has n_{y} inflection points as components in a direction of the decentered section and has nₓ inflection points as components in a direction perpendicular to the decentered section, a following expression is satisfied: n_{y}≧nₓ.

5. The image acquisition apparatus according to claim 2, characterized in that, when z represents a beam propagating direction and both x and y represent a direction perpendicular to z, an aspherical shape of the aspherical mirror not having a rotation axis of symmetry is represented by a following expression:
$$Z ( x , y ) = C \cdot ( {x}^{2} + {y}^{2} ) / [ 1 + {[ 1 - ( 1 + {c}_{1} ) \cdot {C}^{2} \cdot ( {x}^{2} + {y}^{2} ) ]}^{1 / 2} ] + {c}_{5} \cdot ( {x}^{2} - {y}^{2} ) + {c}_{6} \cdot ( - 1 + 2 {x}^{2} + 2 {y}^{2} ) + {c}_{10} \cdot ( - 2 y + 3 {x}^{2} y + 3 {y}^{3} ) + {c}_{11} \cdot ( 3 {x}^{2} y - {y}^{3} ) + {c}_{12} \cdot ( {x}^{4} - 6 {x}^{2} {y}^{2} + {y}^{4} ) + {c}_{13} \cdot ( - 3 {x}^{2} + 4 {x}^{4} + 3 {y}^{2} - 4 {y}^{4} ) + {c}_{14} \cdot ( 1 - 6 {x}^{2} + 6 {x}^{4} - 6 {y}^{2} + 12 {x}^{2} {y}^{2} + 6 {y}^{4} ) + {c}_{20} \cdot ( 3 y - 12 {x}^{2} y + 10 {x}^{4} y - 12 {y}^{3} + 20 {x}^{2} {y}^{3} + 10 {y}^{5} ) + {c}_{21} \cdot ( - 12 {x}^{2} y + 15 {x}^{4} y + 4 {y}^{3} + 10 {x}^{2} {y}^{3} - 5 {y}^{5} ) + {c}_{22} \cdot ( 5 {x}^{4} y - 12 {x}^{2} {y}^{3} + 5 {y}^{5} ) + {c}_{23} \cdot ( {x}^{6} - 15 {x}^{4} {y}^{2} + 15 {x}^{2} {y}^{4} - {y}^{6} ) + {c}_{24} \cdot ( 6 {x}^{6} - 5 {x}^{4} - 30 {x}^{4} {y}^{2} - 30 {x}^{2} y + 30 {x}^{2} {y}^{2} + 6 {y}^{6} - 5 {y}^{4} ) + {c}_{25} \cdot ( 30 {x}^{5} y + 60 {x}^{3} {y}^{3} + 30 {xy}^{5} - 40 {x}^{3} y - 40 {xy}^{3} + 12 xy ) + {c}_{26} \cdot ( 20 {x}^{6} + 60 {x}^{4} {y}^{2} + 60 {x}^{2} {y}^{4} + 20 {y}^{6} - 30 {x}^{4} - 60 {x}^{2} {y}^{2} - 30 {y}^{4} + 2 {x}^{2} + 12 {y}^{2} - 1 )$$
(where, C=1/R (R is a radius of curvature) and cₖ is a constant).

6. The image acquisition apparatus according to claim 2, characterized in that, when z represents a beam propagating direction and both x and y represent a direction perpendicular to z, an aspherical shape of the aspherical mirror not having a rotation axis of symmetry is represented by a following expression:
$$Z ( x , y ) = ( {C}_{x} {x}^{2} + {C}_{y} {y}^{2 } ) / [ 1 + {[ 1 - ( 1 + {k}_{x} ) \cdot {( {C}_{x} x )}^{2} - ( 1 + {k}_{y} ) \cdot {( {C}_{y} y )}^{2} ]}^{1 / 2} ] + AR \cdot {[ ( 1 - AP ) \cdot {x}^{2} + ( 1 + AP ) \cdot {y}^{2} ]}^{2} + BR \cdot {[ ( 1 - BP ) \cdot {x}^{2} + ( 1 + BP ) \cdot {y}^{2} ]}^{3} + CR \cdot {[ ( 1 - CP ) \cdot {x}^{2} + ( 1 + CP ) \cdot {y}^{2} ]}^{4} + DR \cdot {[ ( 1 - DP ) \cdot {x}^{2} + ( 1 + DP ) \cdot {y}^{2} ]}^{5}$$
(where, C^{x}=1/Rₓ (Rₓand R_{y} respectively are radiuses of curvature of xz and yz sections), and kₓ, k_{y}, AR, BR, CR, DR, AP, BP, CP, and DP are constants).

7. The image acquisition apparatus according to claim 3, characterized in that
the image acquisition apparatus includes a configuration in which a collimator optical system common to respective emission ends of the plurality of beams is provided and the emission ends of the plurality of beams are arranged on a plane perpendicular to an optical axis in a front focal position of the collimator optical system, and
an exit pupil is formed in a rear focal position of the collimator optical system by the plurality of beams emitted from the emission ends and made collimated by the collimator optical system,
the wavefront aberration correcting device is arranged in a position optically conjugate with the rear focal position of the collimator optical system, and
at least one aspherical mirror not having a rotation axis of symmetry is arranged between the wavefront aberration correcting device and the deflector arranged in a position optically conjugate with the wavefront aberration correcting device.

8. The image acquisition apparatus according to claim 7, characterized in that
the image acquisition apparatus includes a configuration in which a plurality of collimator optical systems is provided to correspond to respective emission ends of the plurality of beams and the plurality of beams emitted from the emission ends and made collimated by the plurality of collimator optical systems is crossed at one point,
the wavefront aberration correcting device is arranged in a position optically conjugate with a position where the plurality of beams is crossed at one point, and
at least one aspherical mirror not having a rotation axis of symmetry is arranged between the position where the plurality of beams is crossed at one point and the wavefront aberration correcting device.

9. The image acquisition apparatus according to claim 3, characterized in that
the wavefront aberration detecting device is arranged in a position optically conjugate with the wavefront aberration correcting device and
the image acquisition apparatus is configured to be capable of detecting one beam among the plurality of beams with the wavefront aberration detecting device arranged in the position optically conjugate with the wavefront aberration correcting device and measuring wavefront aberration of the beam, and
a correction amount due to the wavefront aberration is applied to the plurality of beams.

10. The image acquisition apparatus according to claim 7, characterized in that
the emission ends of the plurality of beams are optical fiber ends, and
the image acquisition apparatus acquires a tomographic image of the object with interference beam formed by one of the reflected beam and the scattered beam from the object returned to the optical fiber ends and a reference beam propagating through a reference light path different from an optical path of the reflected beam and the scattered beam.

11. The image acquisition apparatus according to claim 7, characterized in that
the emission ends of the plurality of beams are fiber ends and one of the reflected beam and the scattered beam returned to the fiber ends is detected by a light intensity detector, and
the image acquisition apparatus acquires a two-dimensional image from the detected light intensity.
